(19) United States
(12) Patent Application Publication
(10) Pub. No.: US 2010/0169134 A1
(43) Pub. Date: Jul. 1, 2010

(54) FOSTERING ENTERPRISE RELATIONSHIPS

(75) Inventors: Lili Cheng, Bellevue, WA (US); Owen Charles Braun, Seattle, WA (US); Eric I-Chao Chang, Beijing (CN); Susan T. Dumais, Kirkland, WA (US); Dragos A. Manolescu, Kirkland, WA (US); Henricus (Erik) Johannes Maria Meijer, Mercer Island, WA (US); Simon C. Muzio, Woodinville, WA (US); John Oberon, Seattle, WA (US); Jeff Sandquist, Fall City, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/346,942

(22) Filed: Dec. 31, 2008

(51) Int. Cl. G06Q 99/00; G06Q 10/00

(52) U.S. Cl. 705/7

(57) ABSTRACT

The claimed subject matter relates to an architecture that can facilitate, enrich, or nurture relationships in a business enterprise environment. In particular, the architecture can construct a set of profiles associated with entities of the enterprise (e.g., employees, teams, departments, or the enterprise) based upon a wide range of transactions (e.g., behavior, activity, productivity, relationships, explicit or implicit feedback from collaborators . . . ) relating to the entity. Based upon these profiles, the architecture can determine a set of tasks and also identify advantageous relationships, wherein the tasks and relationships are deemed to facilitate accomplishing an objective to benefit the enterprise or entity. In addition, the architecture can nurture or cultivate the advantageous relationships by suggesting suitable behavior or performing opportunistic actions.

### BACKGROUND

The inexorable growth of the Internet in recent times has fostered many new paradigms and new markets for social interaction. In some cases, the Internet has changed the conventional way many people worldwide meet and maintain friends or other relationships. Today, there are abundant examples of social networking sites and services that aid in forming communities, creating and maintaining personal virtual spaces, managing social circles, personal contacts and communications, content sources and so forth.

More particularly, many social networking sites or services exist for matching people with related interests or similar or symbiotic profile characteristics, generally in the province of dating or personal services. In the enterprise domain, however, there are fewer tools that exist to facilitate business-oriented relationships or services. Furthermore, most matching services today share a common disadvantage in that these services focus exclusively on matching individuals. A second common disadvantage is that most any type of profile-based matching is subject to the accuracy or veracity of the data included in the respective profiles. However, such profile data is often authored by the very party it describes and is not subject to any type of verification or validation. Moreover, profiles built from questionnaires that attempt to classify various personality features suffer from the further disadvantage that the questions are often awkward or easily misinterpreted or applied in the wrong context.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one or more aspects thereof, comprises an architecture that can facilitate, enrich, or nurture relationships in a business enterprise environment. In accordance therewith and to other related ends, the architecture can construct a comprehensive profile for an entity based upon various transactions, interactions, and communications associated with the entity. Generally, the entity can relate to an employee of an enterprise, however, the entity can also relate to a group of individuals as well, such as a project team, a department or division, or the entire enterprise.

In more detail, while the transactions are employed to construct the profile, these transactions typically relate to a record of the entity's activities or behavior in real time and in real-world situations. Thus, the transactions can be a much more accurate gage of the entity's profile or personality than are conventional questionnaires or self-describing opinions relating to attributes or qualities. Further, the profile can continually evolve over time to reflect changing roles or activities for the entity, with no need for explicit updating. For example, the transactions can relate to schedules, resumes or employee reviews; to reviews of previous objectives, tasks, or accomplishments; or to preferences or activities associated with tools, devices, data sets, documents, organization, or communication. In addition, the transaction can relate to biological or environmental sensor-based observations such as mood or emotion, expressions, state, location, date or time, or environment. Ultimately, transactions can be employed to determine how the entity works, interacts with others, and various other metrics that can be leveraged to create the profile and provide measures of behavior and personality.

Accordingly, when presented with an objective that is typically intended to benefit the enterprise, the profiles can be examined to determine a suitable task for one or more entity, wherein the task is selected to facilitate accomplishment of the objective. In addition, the architecture can compare the profile of the entity with the assigned task to disparate profiles associated with disparate entities. Based upon the comparison, and with an overarching goal of accomplishing the objective or task, the architecture can identify an advantageous relationship. In particular, the advantageous relationship can be between the entity and one or more disparate entity that is likely to benefit the enterprise, either by accomplishing the objective, connecting individuals who share similar goals or characteristics, or the like.

Furthermore, once the advantageous relationship has been identified, the architecture can provide numerous additional features aimed at nurturing or cultivating the relationship. For example, if the entity requests help with a project, and the advantageous relationship identifies a perfect candidate for providing aid, the architecture can further suggest or automatically enact various actions that are determined or inferred to be favorable to or well-received by the candidate. In other words, the architecture can determine how to approach or interact with various disparate entities based upon the respective profile or personality.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a block diagram of a computer-implemented system that can facilitate, enrich, or nurture relationships in a business enterprise environment.

FIG. 2 is a block diagram of a graphic depiction of various example entities 106.

FIG. 3 provides a block diagram of a graphic depiction of a wide range of example transactions 104.

FIG. 4 illustrates a block diagram of a computer-implemented system that can develop a personality profile for an entity.

FIG. 5 depicts a block diagram of a computer-implemented system that illustrates additional detail with respect to suggesting and fostering advantageous relationships in an enterprise environment.

FIG. 6 is a block diagram of a system that can perform or aid with various determinations or inferences.

FIG. 7 depicts an exemplary flow chart of procedures that define a method for facilitating cultivation of relationships in a business enterprise environment.

FIG. 8 illustrates an exemplary flow chart of procedures that define a method for employing servers and/or sensors to characterize personality types for the profile.

FIG. 9 is an exemplary flow chart of procedures defining a method for providing additional features in connection with identifying the advantageous relationships and/or cultivating the advantageous relationship.

FIG. 10 illustrates a block diagram of a computer operable to execute the disclosed architecture.

FIG. 11 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” or the like can, but need not, refer to a computer-related entity, either hardware, a combination of hardware and software, software, or software in execution. For example, a component might be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” Therefore, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “infer” or “inference” generally refer to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

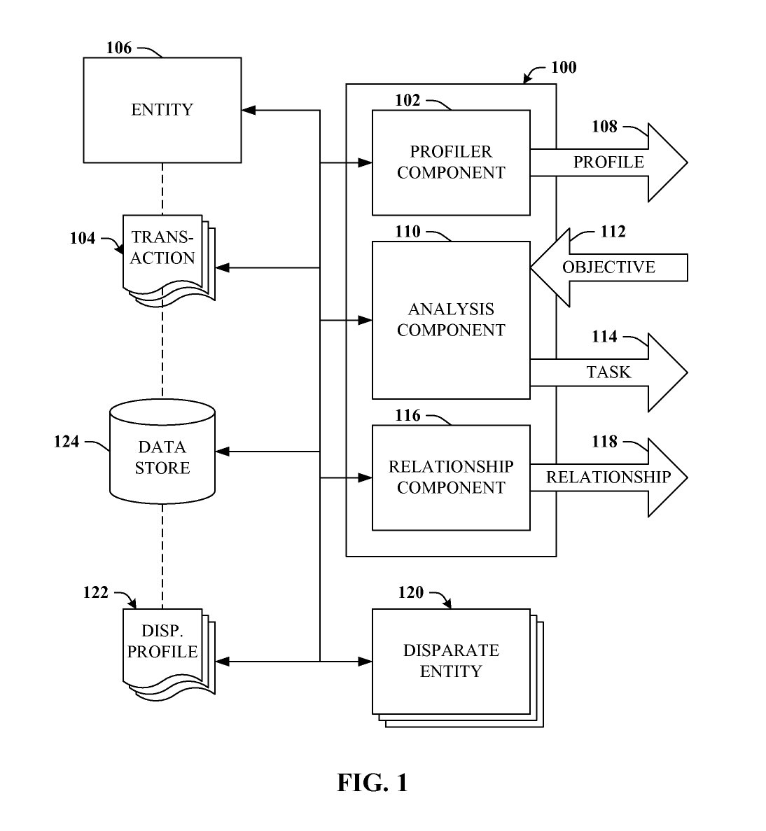

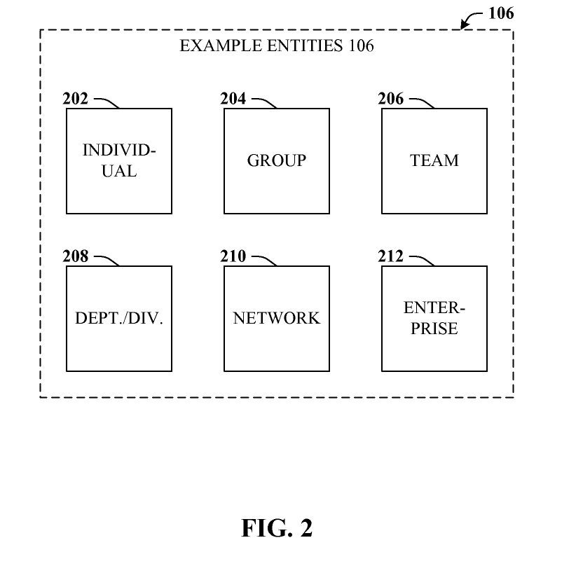

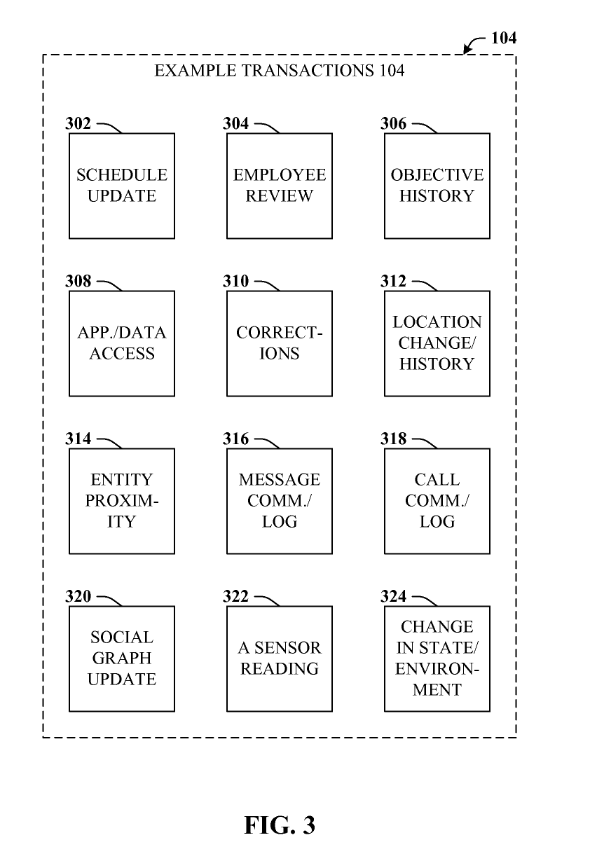

Referring now to the drawings, with reference initially to FIG. 1, computer-implemented system 100 that can facilitate, enrich, or nurture relationships in a business enterprise environment is depicted. Generally, an enterprise environment or setting is intended to relate to a place of business, activities conducted on behalf of a business establishment or enterprise, and/or activities of an employee of the business establishment or enterprise. However, it should be appreciated that the enterprise environment need not necessarily relate only to a business enterprise. Rather, the enterprise environment can relate to other types of organizations or associations such as, e.g., a church, a Boy Scout Troop, etc. As depicted, system 100 can include profiler component 102 that can track or monitor one or more transactions 104 associated with entity 106. It should be appreciated that while many conventional social networking systems are directed to furthering relationships between individuals, the disclosed subject matter can be applicable to relationships between a broader range of entities, as is further detailed in connection with FIG. 2. In addition, further detail with respect to transactions 104 can be found with reference to FIG. 3 infra.

While still referring to FIG. 1, but turning simultaneously to FIG. 2, a graphic depiction of various example entities 106 is provided. Reference numeral 202 illustrates that entity 106 can be an individual. Appreciably, individual 202 can be an employee of the associated enterprise or otherwise affiliated with the enterprise in some way. In other scenarios, however, entity 106 can denote a group 204 of individuals. In other words, features or characteristics that serve as metrics for describing an individual can be abstracted to apply to groups. More particularly, entity 106 can be team 206 comprising multiple individuals with related enterprise goals. As another example, entity 106 can be a department or a division within a hierarchy of the enterprise, often with common leadership or direction, as illustrated by reference numeral 208. Still further yet, entity 106 can be a set of individuals related by way of a social graph or network 210. In addition, in some cases, entity 106 can refer to the entire enterprise 212.

Still referencing FIG. 1, but turning as well to FIG. 3, a graphic depiction of a wide range of example transactions 104 can be found. For instance, example transaction 104 can be schedule update 302 including, for example, creation, modification, and/or deletion of a schedule (e.g., agenda, calendar, timetable, to-do list . . . ) or element of the schedule associated with entity 106. Accordingly, in the cases where entity 106 is an individual (e.g., individual 202 of FIG. 2), schedule update 302 can relate to a change in that individual's planned activities. Similarly, in those cases in which entity 106 refers to more than one individual (e.g., elements 204-212 from FIG. 2), then schedule update 302 can relate to a change in all or a change in a subset of the group member schedule(s).

Other examples of transaction 104 can be an issuance of or update to employee review 304 associated with entity 106; or an issuance of or update to a review of previous objectives or tasks associated with entity 106, denoted as objectives history 306. Typically, employee history 306 will apply to an individual, whereas objectives history 306 can apply to one or both an individual or multiple individuals. For example, objectives history 306 can be a record of an employee's or a group's accomplishments or activities over time, as well as a manner in which those items were accomplished, the value of the activity, the time required, the cost-benefit, and so forth.

In addition, transaction 104 can be an access or input by entity 106 to an application, a tool, or a feature. Likewise, transaction 104 can be an input or access to a data source, either of which can be denoted as access 308. Accordingly, information associated with particular tool sets or data sets interacted with by entity 106, or a skill set of entity 106, can represent transactions 104 that can be monitored to, inter alia, surface data relating to successful endeavors, productivity, or a lack thereof, as well as which tools (or data) are most used or most productive, which tools complement others or create obfuscation, when or how often help features are accessed, and so on. In a similar vein, transaction 104 can be one or more corrections 310 such as deletion, undo, or backward navigation operations, analytical false starts or dead ends or the like.

Furthermore, transaction 104 can relate to location information 312 as well. For instance, transaction 104 can be a change in a location of entity 106, say, leaving a conference room, entering a cafeteria area, visiting other offices or sites and so forth. Appreciably, location can be determined by way of Global Positioning Satellite (GPS) or Wireless Application Protocol (WAP) location features based upon one or more mobile devices equipped by entity 106, based upon cameras, Radio Frequency Identification (RFID), key card access, or other forms of access identification or authorization. In addition, location information can be relative to other entities. For example, entity proximity 314 can be an example of transaction 104 that indicates close associations based upon proximity such as what other entities are present during work, meetings, breaks, lunch, etc. Location information 312 and entity proximity 314 can both relate to current situations as well as to histories or logs of this data.

In another aspect, transaction 104 can be based upon communications of entity 106, such as a message communication 316 or call communications 318, or respective logs thereof Message communication 316 can relate to an email, an instant message, text message, a weblog (e.g., blog), a wiki or other electronic post or communiqué. Call communication 318 can relate to substantially any type of audio, video, or conferencing call. The target entity (e.g., who the communication is to/from) and duration can be recorded as well as certain context or content (e.g., relating to a deadline, last minute updates . . . ). Thus, based upon the context or content, determinations relating to profile 102 can be made by way of natural language processing algorithms or other analysis of language.

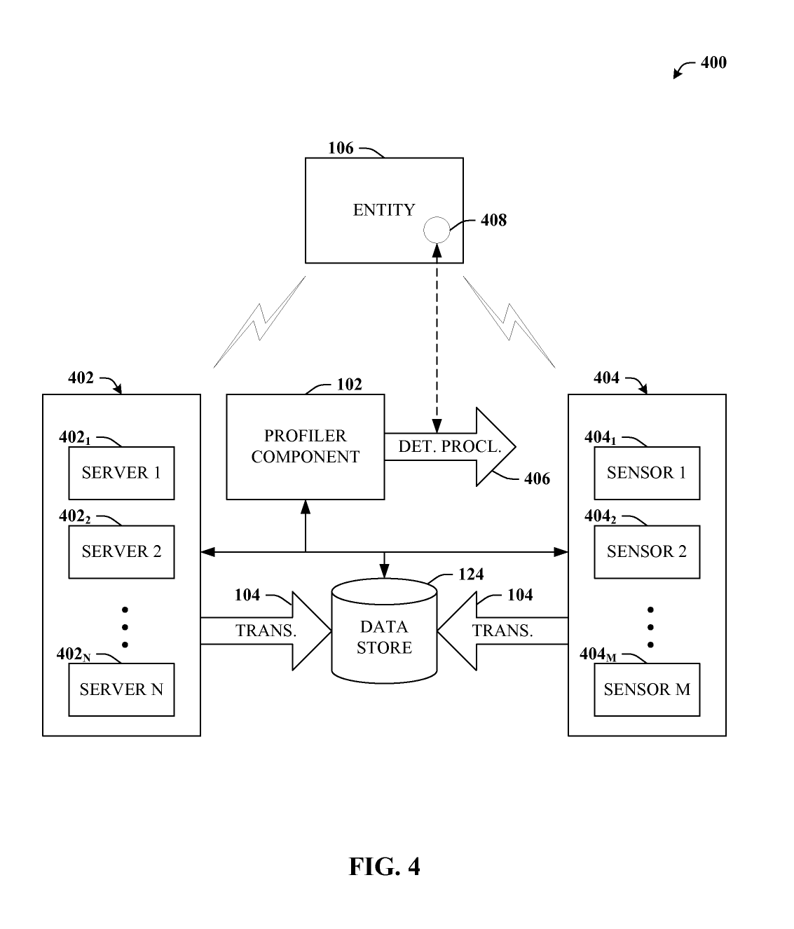

Transaction 104 can also relate to social graph update 320 for entity 106. In the context of an individual, this can be, e.g., adding to or removing from a contact list, whereas in the context of a team or enterprise, update 320 can relate to new hires, lateral transfers and so forth. In addition, transaction 104 can relate to sensor reading 322 or state/environment change 324, which is further discussed in connection with FIG. 4, infra. However, as a brief introduction, these types of transactions 104 can include a biometric reading associated with entity 106, an observational reading associated with entity 106 such as a facial expression (e.g., elation, confusion, or frustration), a biometric or physiological expression (e.g., change in heart rate, blood pressure, sweating, flushing . . . ) a verbal expression (e.g., a sigh, question, or command, or an emotional state), a gesture, a state of the surrounding (e.g., quiet versus hectic environment), a promotion or other job change or task acquisition, a vacation or holiday, world events (e.g., elections, economic situations, conflicts, weather . . . ), personal events (losing weight, had a child . . . ) and so on.

Continuing the discussion of FIG. 1, profiler component 102 can construct or update profile 108 associated with entity 106 based upon one or more transactions 104 relating to entity 106. Given the examples provide supra, it is readily apparent that profile 108 can be quite comprehensive in terms of an entity's activity, behavior, preferences, strengths/weaknesses and so forth. Moreover, profile 108 can include other data such as demographic information, entity-specific settings or defaults, economic transactions (e.g., cafeteria purchase or company merger), etc.

System 100 can also include analysis component 110 that can receive objective 1 12. Objective 112 can be a goal-oriented result that is deemed to or intended to benefit an enterprise. Upon receipt of objective 112, analysis component 110 can determine or infer task 114, which can be an activity or assignment that facilitates accomplishment of objective 112. Task 114 can be selected based upon an examination of profile 108 such that the determined task 114 is suitable for entity 106. A number of illustrative examples of these aspects are detailed below.

In addition, system 100 can further include relationship component 116 that can identify advantageous relationship 118 between entity 106 and disparate entity 120. In particular, relationship component 116 can compare profile 108 to one or more disparate profiles 122 associated a respective number of disparate entities 120. By comparing available profile information or other suitable data, relationship component 116 can thus determine or infer disparate entity 120 that is likely, capable of, or most suited to aid entity 106 in accomplishing task 114 and/or efficiently completing objective 112 aimed at benefiting the enterprise.

Still referring to FIG. 1, it should be understood that system 100 can also include or be operatively connected to data store 124. Data store 124 is intended to be a repository for all or portions of data, data sets, or information described herein or otherwise suitable for use with the claimed subject matter. For example, data store 124 can include all or portions of information associated with the enterprise, and can serve as a warehouse for transactions 104, profile 108, and/or disparate profiles 122. Data store 124 can be centralized, either remotely or locally cached, or distributed, potentially across multiple devices and/or schemas. Furthermore, data store 124 can be embodied as substantially any type of memory, including but not limited to volatile or non-volatile, sequential access, structured access, or random access and so on. It should be understood that all or portions of data store 124 can be included in system 100, or can reside in part or entirely remotely from system 100.

Referring now to FIG. 4, system 400 that can develop a personality profile for an entity is illustrated. In general, system 400 can include profiler component 102 that can construct profile 108 based upon transactions 104 associated with entity 106 as detailed supra. In order to examine or monitor transactions 104, these transactions 104 can be intermediately stored to data store 124 for later recall or access by profiler component 102 or another component. Additionally or alternatively, profiler component 102 can be operatively coupled to a set of servers 402 employed to record various types of transactions 104. Likewise, profiler component 102 can be operatively coupled to a set of sensors 404 employed to monitor entity 106 or a behavioral characteristic thereof in order to record transaction 104. In addition, profiler component 102 can monitor the environment of entity 106 and/or related disparate entities 120 such as those entities that are in close proximity to or working in conjunction with entity 106.

Given the available richness of potential transaction 104, it is readily apparent that servers 402 and sensors 404 can be commensurately diverse to capture the various types of transactions 104. For example, servers 402 can be one or more data or informational servers that can provide secured and/or authorized access to and tracking of scheduling information, application or data use, typos or corrective inputs, social graphs, and many types of transactional records related to entity 106 discussed in connection with FIG. 3, or that are otherwise suitable. Similarly, sensors 404 can be employed to detect numerous types of transactions 104 associated with entity 106 as well, many of which were also detailed supra in connection with FIG. 3. For example, sensors 404 can include cameras or microphones for detecting identity or location, emotion or mood, or even certain biometric information (e.g., fingerprints, voice patterns). Of course, numerous other servers 402 and sensors 404 are contemplated to be of use to the claimed subject matter as will become more apparent with the remainder of the discussion herein.

In particular, profiler component 102 can include in profile 108 determined proclivity characteristic 406 associated with entity 106, wherein proclivity characteristic 406 relates to observed propensity 408 of entity 106 determined based upon one or more transactions 104. Generally, observed propensity 408 of entity 106 can be detected by servers 402 or sensors 404 as detailed supra. Based upon propensity 408, profiler component 102 can determine or infer proclivity characteristic 406. Appreciably, either or both of proclivity characteristic 406 or propensity 408 can be based upon established psychological principles or classification, with transactions 104 forming the basis of psychometric inputs and/or evaluations. As one example, the well-known Myers-Briggs Type Indicator (MBTI) can be employed with the indicator representing pre-defined or inferred proclivity characteristics 406 or propensities 408. MBTI seeks to measure psychological preferences or profiles relating to perception and decision-making based upon an assessment of psychometric inputs, and is thus suitable for numerous potential classifications. Of course, other psychological and/or personality typing characterizations can be suitable as well.

In order to illustrate the above-mentioned features, determined proclivity characteristic 406 can be a preferred modality of communications by entity 106. For example, this feature can relate to which applications or devices entity 106 chooses over others as well as the context or situations that alter this preference. As another example, proclivity characteristic 406 can be a punctuality rating of entity 106. Hence, habits of entity 106 relating to timeliness or tardiness, as well a tolerance for such in disparate entities 120 can be employed to develop one or more proclivity characteristic 406. Furthermore, proclivity characteristic 406 can relate to a rate of communication (e.g., how often entity 106 communicates with others or communicates in the aggregate), a response time (e.g., how quickly entity 106 responds to different types of communiqués or assignment, or expectations of the same for disparate entities 120), or a target of communication (e.g., with whom does entity 106 tend to direct communications).

Proclivity characteristic 406 can also relate to a tendency to initiate, to attend, or to avoid meetings; or to initiate or avoid interaction with one or more disparate entity 120. Additionally, proclivity characteristic 406 can relate to various preferences of entity 106 such as a preference related to organization or structuring of assignments; a preference related to assignment of responsibilities to others such as to whom or in what context; or a preference related to completion of responsibilities. In another case, proclivity characteristic 406 can relate to a measure of social capital (e.g. a number of relationships, the status of those other parties, the strength of the relationships . . . ). Other examples of proclivity characteristic 406 can include a receptiveness by entity 106 to interruptions or requests, perhaps based upon a current state or workload or other contextual information; or, perhaps based upon the current state or context, a favorable strategy when directing an interruption or request to entity 106 that can increase the likelihood of a successful outcome. Of course, numerous other examples of proclivity characteristic 406 are possible without departing from the scope of the appended claims. For example, proclivity characteristic 406 and/or propensity 408 can be determined or inferred from analysis of natural language features included in an oral or written communication. Moreover, given that entity 106 can relate to groups of individuals, proclivity characteristic 406 or propensity 408 can relate to groups as well. For example, a group or enterprise can be classified as innovative or conservative or described in terms of preferred modalities in the aggregate and so forth.

Moreover, it should also be appreciated that because all or portions of profile 108 (and/or proclivity characteristic 406) can be obtained from direct observation in a real-world setting, factual analysis, or over a long period of time, the data can be much more reliable and/or accurate than conventional systems. Specifically, conventional systems create profiles from a person's statements rather than drawing from actual behavior. For example, conventional systems typically restrict profiles to individuals rather than a collection of individuals as is possible in the disclosed subject matter. Furthermore, conventional systems typically allow an individual to select various characteristics from a list or pose hypothetic questions to derive similar results. Accordingly, these types of profiles tend to be less accurate or based upon an individual's perception of oneself, which may not be realistic, may be based upon a short-term fad or whim that is not time test, or may even be insincere. Naturally, with less accurate profiles, any type of matching conventional systems perform based on such profiling will likewise be less accurate or useful.

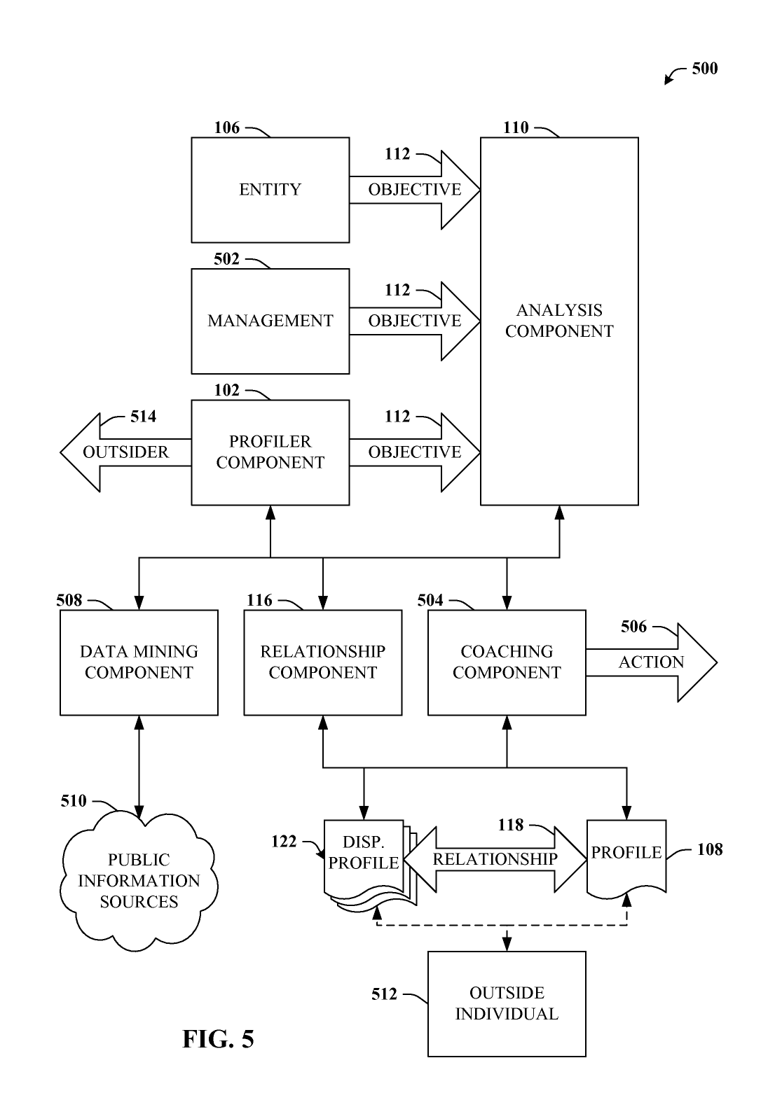

Appreciably, with the foregoing in mind and once all or portions of profile 108 and proclivity characteristics 406 have been constructed for entity 106 (and likewise those for disparate entities 120), it is readily apparent that advantageous relationships 118 can be suggested to aid in accomplishing objective 112, and those advantageous relationships 118 can be effectively nurtured or sustained, which is discussed in more detail with reference to FIG. 5.

Turning now to FIG. 5, system 500 that illustrates additional detail with respect to suggesting and fostering advantageous relationships in an enterprise environment is depicted. Generally, FIG. 5 assumes that profile 108 and disparate profiles 122 have been constructed, e.g., by profiler component 102 as described in detail supra. In accordance therewith, system 500 can include analysis component that can receive one or more objectives 112 intended to benefit the enterprise. As depicted, objective 112 can be received from one or more sources. To best illustrate each case, a concrete example of each is provided, however, it should be appreciated that the described examples are not necessarily intended to be limiting, as other cases or scenarios can exist.

As an initial example, objective 112 can be received from entity 106. Thus, for example, consider Ashley (e.g. entity 106) who believes she could be more productive at work if she learned to organize and search her emails more effectively. In this case, objective 112 can be expressly stated and/or input by Ashley, relating to email productivity or time management. Upon receiving this input (e.g., objective 112), analysis component 110 can determine task 114 aimed at accomplishing this objective 112. In this case, or at least at this stage, task 114 might simply be to seek help from a knowledgeable source for learning how to manage email more effectively, however in other cases or later stages, task 114 can be much more complex.

Relationship component 116 can also be apprised of both objective 112 and task 1 14. Thus, relationship component 116 can examine disparate profiles 122 to identify one or more disparate entities 120 who can help Ashley accomplish objective 112 and/or task 114. Now suppose relationship component 116 identifies several people who are quite knowledgeable and effective in email management. Many of these knowledgeable parties, however, are up against important deadlines, one is on sabbatical, and another has been ill. These and other aspects can be determined based upon transactions 104 and applied to the respective party's profile by profiler component 102. Accordingly, relationship component 116 narrows the field to two disparate entities 120, Ross and Sandra. With further analysis, relationship component 116 determines that Ashley and Ross have numerous shared proclivity characteristics 406, similar personality types, and, furthermore, Ashley and Ross worked together on a project two years ago, so potential awkwardness related to meeting one another is not present or can be mitigated. In addition, according to Ross's profile, it is apparent that he could benefit from interaction with Ashley as well, given that a number of his projects relate to areas of expertise for Ashley.

Thus, relationship component 116 can determine that a relationship between Ashley and Ross can be an advantageous relationship 118 for accomplishing objective 112. Moreover, it can further be identified that Ross is currently in the break room and probably has time to speak with Ashley immediately. Accordingly, task 114 can be updated to indicate Ashley should speak with Ross, whose contact information is as follows, and who is also in the break room down the hall right now. Naturally, numerous additional aspects can be employed many of which will be discussed infra.

As a second case, objective 112 can be expressly provided by management 502 such as by, e.g., a supervisor or administrator of entity 106, a supervisor or administrator of one or more disparate entities 120, or that for the enterprise as a whole. Thus, objectives 112 can be driven based upon goals of management 502 in a top-down manner. As an example, consider Bob, the CEO of the enterprise, who believes it would be beneficial for the acquisitions division to work more closely with R&D. This objective 112 can be input to analysis component 1 10. Further suppose that Ashley works in R&D while Ross works in acquisitions. In that case, then advantageous relationships 118 can be identified between Ashley and Ross, as well as between other similarly compatible personnel, based upon the analysis and comparisons described herein. As another example, consider that Bob decides the company should embrace new paradigms or new technologies such as public emails or open source software products. Such a change can create much confusion and internal upheaval. However, inferences or suggestions can be provided to regroup entities 106 and/or rewire the structure of the enterprise to adapt to the new paradigm. As a related example, similar advantageous relationships 118 can be determined in event that distinct entities 106 (e.g., groups or teams) worked with similar technologies or toward similar goals, yet one or more of these entities 106 are dissolved. In that case, any remaining entities 106 (or members thereof) can be benefited by the knowledge or experience of the discontinued entities 106 (or members thereof), with advantageous relationship 118 intelligently determined to, for example, optimize the potential exchanges.

In yet another case, objective 112 can be provided by profiler component 102. Recall, profiler component 102 can directly observe transactions 104. With that in mind, consider the situation in which Ashley is struggling to complete a portion of an assignment that relates to, say, data storage, an area she is not well versed. Such a determination can be made by, e.g., facial or verbal expressions that indicate frustration, numerous edits or deletes to that portion of the document, accesses to (potentially remedial) resources on the topic, a drop in productivity or output, email communication and the emotional charge associated therewith, and so forth. Based upon these or similar transactions 104, profiler component 102 can automatically determine or infer that Ashley needs assistance, and transmit this data to analysis component 110 as objective 112. Relationship component 116 can then determine a suitable disparate entity 120 for providing such assistance in much the same way as described above, and this information can be output to Ashley. As another example, consider the case in which Ashley and Ross are both working on similar technologies, even though they are in different divisions and do not currently work together or collaboratively review ideas. In this case, profiler component 102 and/or relationship component 116 could identify that interaction between the two could be quite beneficial. As still another example, consider the case in which entity 106 is a development team, wherein communication and productivity are diminishing. It can be inferred that the source of this decline is due to the fact that the team mostly communicates via email, although many of the team members do not prefer or work well with that type of communication. Accordingly, profiler component 112 can infer objective 112 of meeting more in person or collaborating with other devices or tools apart from email.

While the above cases are intended to serve as examples of the sources and purposes of objectives 112, it should be understood that the claimed subject matter can apply to numerous other scenarios as well. For example, in the above cases, advantageous relationship 118 was often identified based upon a characteristic of the disparate profile 122 (e.g., Ross appears suitable to work with Ashley). Yet, consider the case in which Ashley desires to switch jobs or transfer to a new department, for instance. Analysis component 110 can examine Ashley's profile 108 to determine relevant characteristics, while relationship component 116 can initially identify which division (e.g., disparate entity 120), based upon Ashley's skills or traits, would make for a good fit. In addition, relationship component 116 can identify the advantageous relationships 118 that will further a move to the desired department. Thus, relationship component 116 can identify a first advantageous relationship 118 (e.g., the best division for Ashley to work) and then a second advantageous relationship 118 (e.g., the right person to talk to about the transfer, say a manager or someone who has sway with the manager). Appreciably, this situation illustrates that advantageous relationship 118 can be identified based upon a characteristic of profile 108 rather than based upon disparate profile 122, or at least pivoting first upon such information.

Furthermore, in an aspect, the characteristic (e.g., of disparate profile 122) can be a desired characteristic for accomplishment of objective 112 or a correlated characteristic indicative of the desired characteristic. For example, consider the situation in which Ashley, a project manager, is putting together a team for a specified task. One position for the team will require some special skills for which she knows Ross will be perfect. However, Ross is unavailable for this project so Ashley must find an alternative, yet she has no real idea where to start. Now suppose the special skills required relates to an innate strength in spatial visualization, or some ability that is not well defined or understood or even tracked by conventional enterprise metrics, and therefore has very little if any data for which to determine this strength.

However, it might be known that individuals with an avid interest in, say, music, often are very good at spatial visualization. In fact, Ross's resume indicates an interest in several musical instruments. Appreciably, known characteristics associated with Ross, as well as known or inferred correlations can be utilized to identify an alternative for the position Ashley seeks to fill. In some cases, data deemed to be non-relevant can be filtered or reduced in value or weight. As another example, based upon objective 112 or task 114, it can be determined or inferred that the current structure of a project is lacking some expertise. For example, suppose Ashley often discusses a particular topic with an engineer, yet the topic would be better pursued with a tester based upon an analysis of the enterprise structure or contextual inference relating to the topic. Or, rather than discussing certain matters with management, those matters should be disclosed to an attorney instead.

It can be readily understood that the initial portions of the detailed description described herein relate largely to example illustrations of building comprehensive profiles (e.g., profiles 108 and disparate profiles 122), whereas some succeeding portions relate primarily to employing such data for identifying advantageous relationships 118, in accordance with the appended claims. What follows in this section is intended primarily to detail additional beneficial aspects or features that can be employed to cultivate or enrich the advantageous relationships 118, once such relationships are identified. In particular, according to another aspect, system 500 can also include coaching component 504 that can perform automated action 506, wherein action 506 can be intended to cultivate or foster advantageous relationship 118 between entity 106 and one or more disparate entities 120 (e.g., as identified based upon the respective profiles 108, 122).

To provide various concrete examples, consider the following. Automated action 506 can be providing an identity of disparate entity 120 to entity 106. Thus, drawing once more upon the previous scenarios, Ashley can be provided the identity (and other suitable/authorized information) of Ross, which has already been introduced. As a more robust example, action 506 can relate to scheduling a meeting or a series of recurring meeting that include entity 106 and disparate entity 120. The scheduling can be based upon respective schedule information as well as various other factors. For instance, deference can be given to the most senior participant in terms of time or location of the meeting or to a participant with special needs. As one example, meetings can be scheduled for breakfast since that is when most people have free time, and scheduled events need not mandate that work is discussed, but can be looser in form to help build camaraderie between individuals. This camaraderie can be deemed to directly benefit the enterprise, but can also be deemed to indirectly benefit the enterprise by, e.g., improving the happiness or satisfaction of employees by uniting those with the potential to be close friends or work companions.

Moreover, it should be underscored that coaching component 504 can undertake the scheduling (or another) action 506 automatically, removing the burden, the biases, and/or the lack of information of a human actor planning the meeting. In this sense, coaching component 504 can act as a personal secretary to entity 106 in many respects. Furthermore, by automating these and similar tasks, relationships can be more effectively fostered, since many relationships fail to attain their full potential because of the time and effort involved in planning. However, these and other activities can be performed by, requisitioned by, or delegated to coaching component 504.

Furthermore, action 506 can relate to setting up an impromptu engagement that includes entity 106 and disparate entity 120. Such can be based upon respective current activity or current geographic proximity. For example, it can be identified, e.g., by way of transactions 104 that Ashley missed the last two meetings with Ross, or that both parties are currently working on related ideas but do not interact much yet probably should, or that Ashley and Ross used to interact often but have recently been out of touch, or any of numerous other possibilities. Suppose further that Ashley and Ross are both currently eating lunch and in the same cafeteria. Accordingly, coaching component 504 can suggest that Ashley and Ross eat their lunch together rather than sit separately or alone.

Automated action 506 can also relate to reminding entity 106 to reply to a communiqué, offer suggestions in a reply that beneficially tailor the reply based upon the disparate entity's profile or personality, or to generating the communiqué on behalf of entity 106 and propagating the communiqué to disparate entity 120. For example, suppose Ross's profile indicates that he generally replies to emails immediately, while Ashley's profile indicates that she often leaves emails in her inbox for some time before responding (e.g., respective proclivity characteristics 406). Furthermore, it can be inferred or known and recorded as a proclivity characteristic that Ross becomes annoyed when others do not respond promptly. Accordingly, Ashley's normal behavior might cause some friction in this regard. Thus, coaching component 504 can remind Ashley to reply to Ross or in some cases, such as when the response comprises information that can be determined from Ashley's or Ross's transactions, craft the response automatically. In yet another example, the length and level of brevity of the email or replies thereto can also be a part of the profile which is used to coach better formation of relationships. Appreciably, some people do not mind receiving very large communications, either in terms of body text or attachments, while others prefer to receive links to the document on a shared folder. As another example, coaching component 504 can provide automated follow-ups such as a summary of or minutes of a collaborative session or automatically generate reviews, activity summaries, or completed endeavors.

Additionally, automated action 506 can relate to suggesting suitable behavior to entity 106 for interacting with disparate entity 120 based upon one or more proclivity characteristic 406 associated with disparate entity 120. For example, given that profiler component 102 can develop a broad range of proclivity characteristics 406, coaching component 504 can employ this data to aid Ashley in fostering a relationship with Ross. For instance, Ashley can be apprised of, say, the best way to approach Ross with a request for help, or the best way to approach Ross when he is busy. Perhaps Ross likes a particular type of chocolate or needs help with one of his own assignments. Accordingly, coaching component 504 can suggest that Ashley bring Delafee dark chocolate to impress Ross or to a recommendation that Ashley use her influence or knowledge to help Ross with his own assignments. As another example, suppose Ross prefers succinct, straight-to-the-point communication, then Ashley can be counseled by coaching component 504 to approach Ross with a concise outline and only a minimum of formalities. Similarly, especially in the cases where entity 106 relates to multiple individuals such as a team or enterprise, action 506 can be, e.g., recommending for or against a merger between the entity and the disparate entity, or suggesting competitive, collaborative, or defensive activities for the entity with respect to the disparate entity.

It should also be appreciated that in some cases, task 114 can involve interacting with an outside individual 512. For example, outside individual 512 can be an individual employed by a disparate enterprise. In these or other situations, relationship component 116 can identify disparate entity 120 that has an established relationship with outside individual 512. For illustrative purposes, consider the case where Ashley is tasked with setting up an industry-wide conference and would like to get members of XYZ Corp., a chief competitor, involved. However, Ashley is not at all familiar with their employees or hierarchy. On the other hand, Ross used to work at XYZ Corp. and according to various transactions 104, he still maintains active relationships with a few XYZ employees. Hence, relationship component 116 can identify Ross to Ashley and further suggest that a relationship between the two can be advantageous.

Additionally or alternatively, profiler component 102 can be operatively coupled to data mining component 508 that can search public sources 510 for information associated with outside individual 512. For example, Internet sources such as LinkedIn, MySpace, Facebook, or public blogs or bios are often rich sources of information relating to outside individual 512, and these sources can be mined employing well-known web-crawling techniques. In some cases, profiler component 102 can construct outsider profile 514 for outside individual 512 based upon public information sources 510 or other sources of data. Thus, various features described herein that reference profile 108 or disparate profile 120 can employ outsider profile 514 as well. It should be further appreciated that profiler component 102 can employ information obtained from public sources 510 for augmenting profile 108 or disparate profile 120. Thus, such sources need not apply only to outside individual 512, but can be equally well-suited for entity 106 or disparate entity 120.

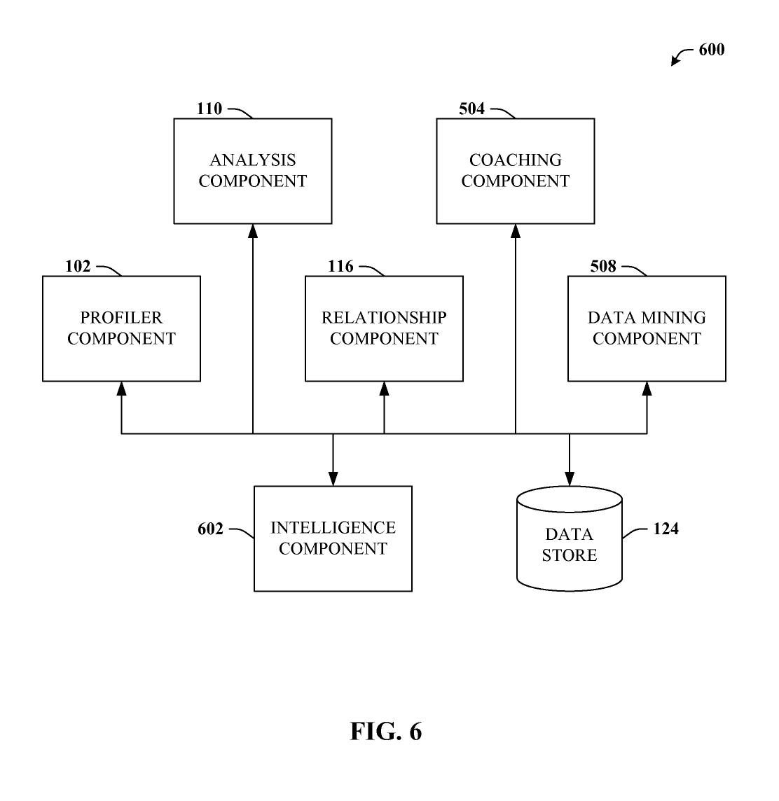

Referring now to FIG. 6, system 600 that can perform or aid with various determinations or inferences is provided. In particular, system 600 can include profiler component 120, analysis component 110, relationship component 116, coaching component 504, and/or data mining component 508, that in accordance with what has been described supra, can make intelligent determinations or inferences. For example, all or portions of these components can support machine learning techniques, potentially based upon historic data or past decisions, to refine various inferences relating to profiling, assigning tasks 114 appropriately, identifying and optimizing advantageous relationships 118, and so forth. Additionally or alternatively, some or all of the described components can employ Bayesian principles or stochastic techniques to predict preferred or likely outcomes based upon data aggregated from transactions 104 or from other sources.

In addition, system 600 can also include intelligence component 602 that can provide for or aid in various inferences or determinations. It is to be appreciated that intelligence component 602 can be operatively coupled to all or portions of components 102, 110, 116, 504, or 508. Additionally or alternatively, all or portions of intelligence component 602 can be included in one or more components described herein. Moreover, intelligence component 602 will typically have access to all or portions of data sets described herein, such as data store 124, and can furthermore utilize previously determined or inferred data.

Accordingly, in order to provide for or aid in the numerous inferences described herein, intelligence component 602 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g. naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

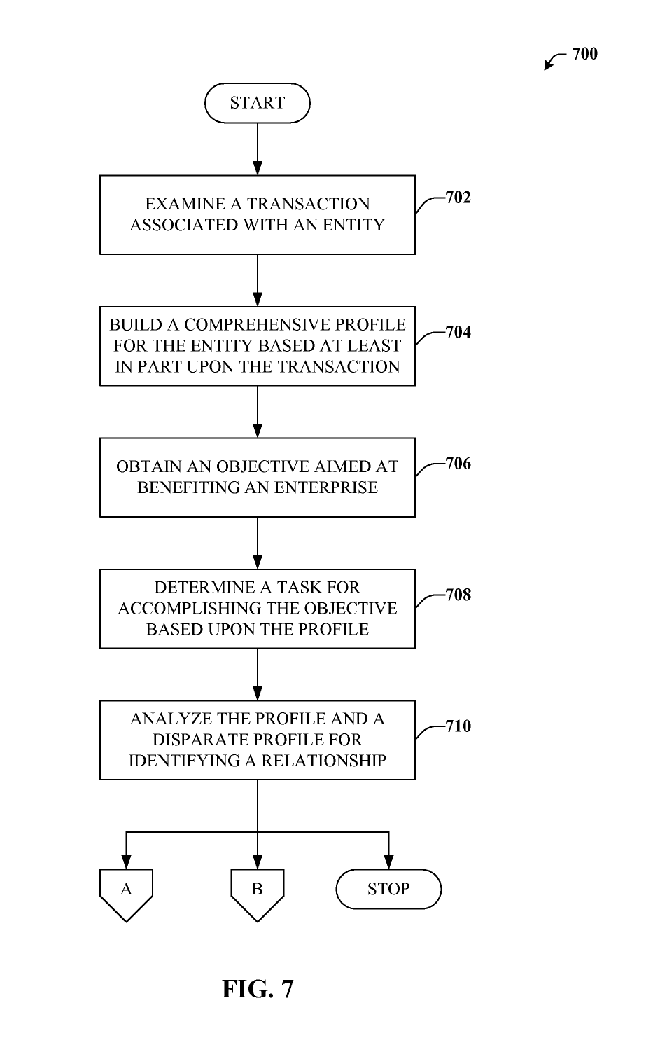

FIGS. 7, 8, and 9 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

With reference now to FIG. 7, exemplary computer implemented method 700 for facilitating cultivation of relationships in a business enterprise setting is illustrated. Generally, at reference numeral 702, a transaction associated with an entity can be examined. Typically, the entity can be an individual or employee of the enterprise, a team of individuals with related enterprise-based goals, a department or division within a hierarchy of the enterprise, a set of individuals related by way of a social graph or network, or the enterprise itself.

Likewise, the transaction can be substantially any action or behavior of the entity that can be observed, identified, and/or recorded. Some examples of such include: a scheduling update, an issuance or update to an employee review or a review of previous objectives or tasks associated with the entity, an access or input to an application, a tool, a feature, or a data set, a change in a location of the entity, a proximity to other entities, or a history thereof, a communication of an electronic message or call or a history or log thereof, a reading associated with a biometric, a facial expression, a verbal expression, or a gesture, a change in environment or situational state of the entity, or one or more corrective inputs.

At reference numeral 704, a comprehensive profile for the entity can be built based at least in part upon the one or more transactions. At reference numeral 706, an objective aimed at benefiting an enterprise can be obtained. The objective can be received from the entity, from management, or can be dynamically inferred based upon transactions 104 (e.g., an inference that the entity needs a particular type of aid). It should be appreciated that while the objective is intended to benefit the enterprise, the benefit can be an indirect one such as increasing the satisfaction, happiness, or enjoyment of the entity.

Next to be described, at reference numeral 708, a task for accomplishing the objective can be determined based upon the profile. For example, suppose the objective is received from management that two departments so work together more closely. In that case, the task for each member of the respective departments can be different, based upon the unique attributes of each respective profile, even though all tasks can be aimed at accomplishing the objective. At reference numeral 710, the profile and a disparate profile associated with a disparate entity can be analyzed for automatically identifying an advantageous relationship in connection with the objective or task.

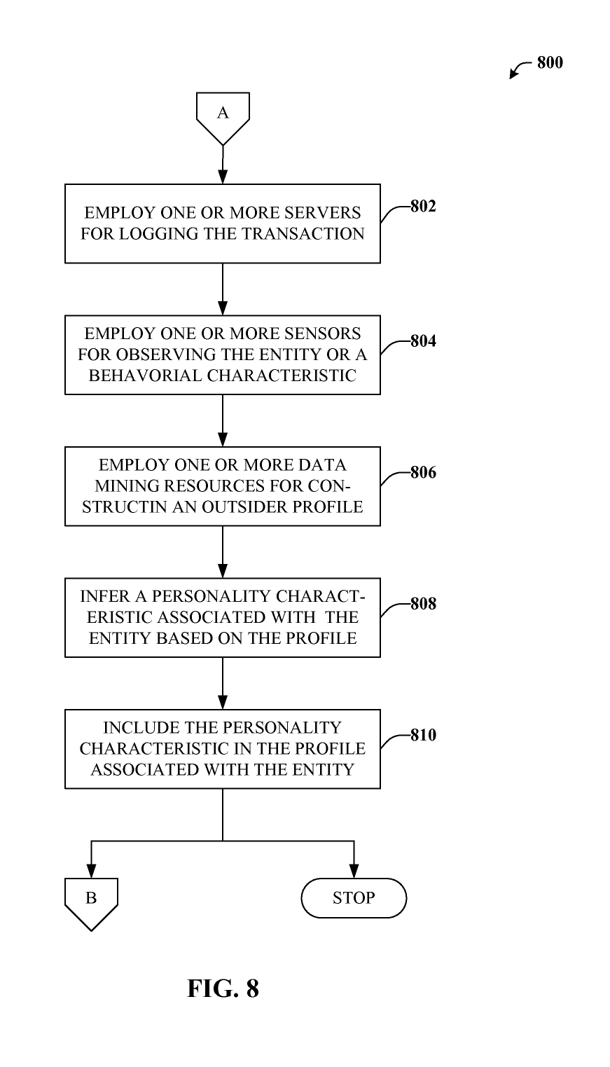

Referring to FIG. 8, exemplary computer implemented method 800 for employing servers and sensors to characterize personality types is depicted. At reference numeral 802, one or more servers can be employed for logging the transaction. Typically, these servers will relate to transactions histories associated with data accesses or device, application, tool, or feature accesses, but can relate to many other aspects as well, such as communications or travel. Appreciably, such data can be a rich source of mining habits, preferences, and/or behavior of the entity in addition to serving as a baseline template for various relationships and practical social hierarchies. Moreover, especially in the context of entities that comprise multiple individuals, such as enterprises, the data mining can related to characteristics of member entities, financial statements, press coverage, or other suitable public or accessible information.

At reference numeral 804, one or more sensors can be employed for observing the entity or an associated behavioral characteristic. As with the set of servers, any number of sensors can be employed to build useful information relating to the entity, and can be especially effective in deriving the entity's current environment, state, mood, or the like. Similarly, at reference numeral 806, one or more data mining resources can be employed for constructing an outsider profile relating to a non-enterprise individual. Appreciably, the one or more data mining resources can also be employed for supplementing the profiles associated with the entity or the disparate entity.

Whether received by way of enterprise servers, sensors, or mined from outside and/or public sources, all or portions of these various transactions relating to the entity can be utilized to develop the profile, as detailed in connection with reference numeral 704. In addition, at reference numeral 808, a personality type or characteristic associated with the entity or a propensity of the entity can be inferred based upon the transactions. And, at reference numeral 810, the proclivity characteristic can be included in the profile associated with the entity.

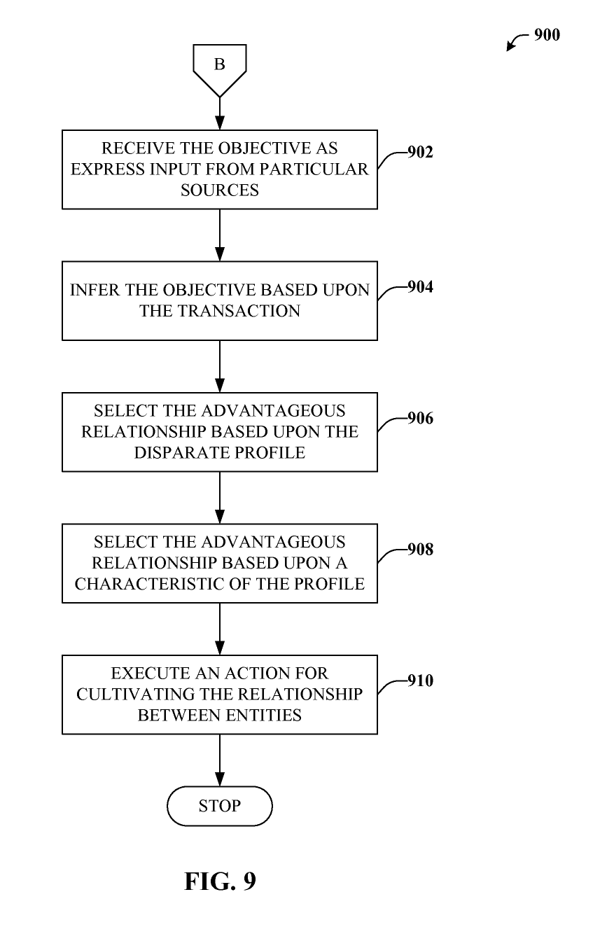

With reference now to FIG. 9, method 900 for providing additional features in connection with identifying the advantageous relationships and/or cultivating the advantageous relationship is illustrated. Generally, at reference numeral 902, the objective detailed in connection with reference numeral 706 can be received as express input from at least one of the entity, a manager of the entity, a manager of the disparate entity, or a manager of the enterprise. Accordingly, the objective can be provided either by the entity (e.g., trying to mitigate a known issue or deficiency), or in a top-down manner by management. In contrast, at reference numeral 904, the objective can be dynamically inferred based upon one or more transactions. Thus, through analysis, an issue, deficiency, or weakness of the entity can be determined and acted upon even without express knowledge or understanding by the entity.

Furthermore, at reference numeral 906, the advantageous relationship identified at reference numeral 710 can be selected based upon a characteristic featured in the disparate profile associated with the disparate entity. However, at reference numeral 908, the advantageous relationship can be selected based upon a characteristic featured in the profile associated with the entity. In other words, depending upon the situation or the structure of the comparisons, the primary factor in identifying the advantageous relationship can reside in either one of the profile or the disparate profile. For example, when the entity desires to find a disparate entity with a particular skill versus when the entity desires to find a position for which his own skills are well-suited can each pivot on different criteria.

At reference numeral 910, an automated action from a set of automated actions for cultivating the advantageous relationship between the entity and the disparate entity can be executed. Typically, the automated action will relate to hints or suggestions about the disparate entity's psyche, personality, or behavior that can be leveraged to improve the interaction between the entity and the disparate entity. For example, the automated action can be or include automatically scheduling a meeting or a series of recurring meetings that include at least the entity and the disparate entity; scheduling impromptu meetings, potentially based upon proximity or current activity; reminding the entity and/or automatically responding on behalf of the entity in connection with communiqués from the disparate entity; suggesting suitable behavior or protocol for interacting with the disparate entity based upon a proclivity characteristic or type of the disparate entity; and so forth.

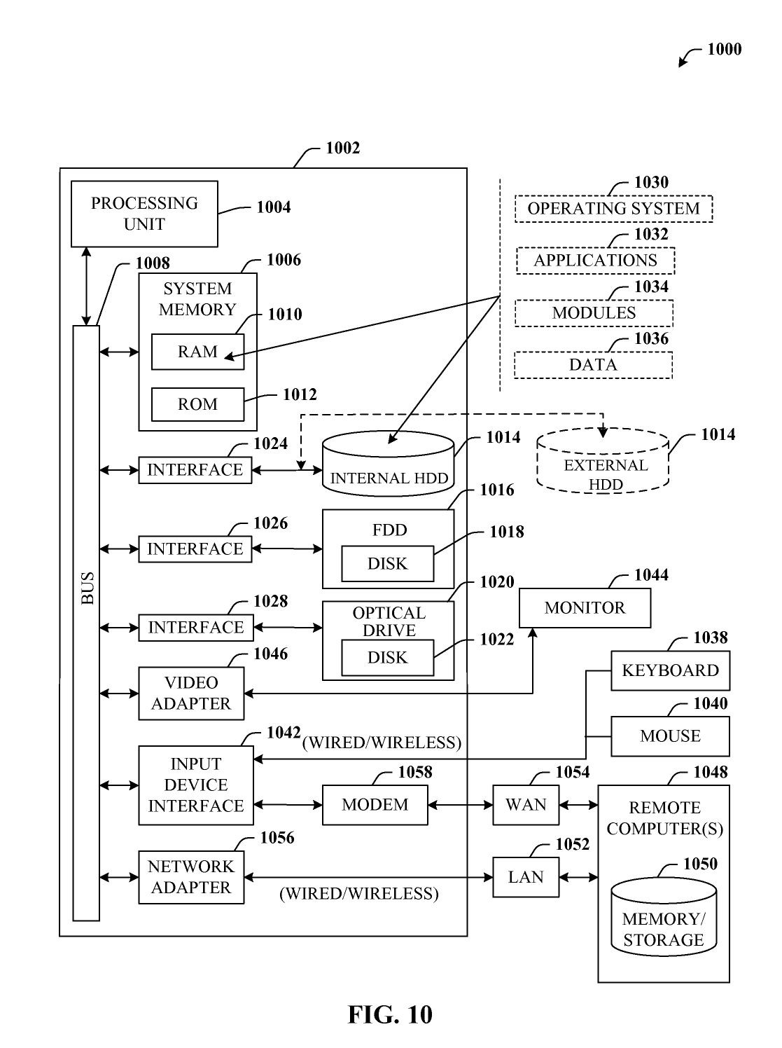

Referring now to FIG. 10, there is illustrated a block diagram of an exemplary computer system operable to execute the disclosed architecture. In order to provide additional context for various aspects of the claimed subject matter, FIG. 10 and the following discussion are intended to provide a brief, general description of a suitable computing environment 1000 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the claimed subject matter includes a computer 1002, the computer 1002 including a processing unit 1004, a system memory 1006 and a system bus 1008. The system bus 1008 couples to system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the claimed subject matter can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, a mobile device, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11b) or 54 Mbps (802.11a) data rate, for example, or with products that contain both bands (dual band), so the networks can provide real-world performance similar to the basic “10BaseT” wired Ethernet networks used in many offices.

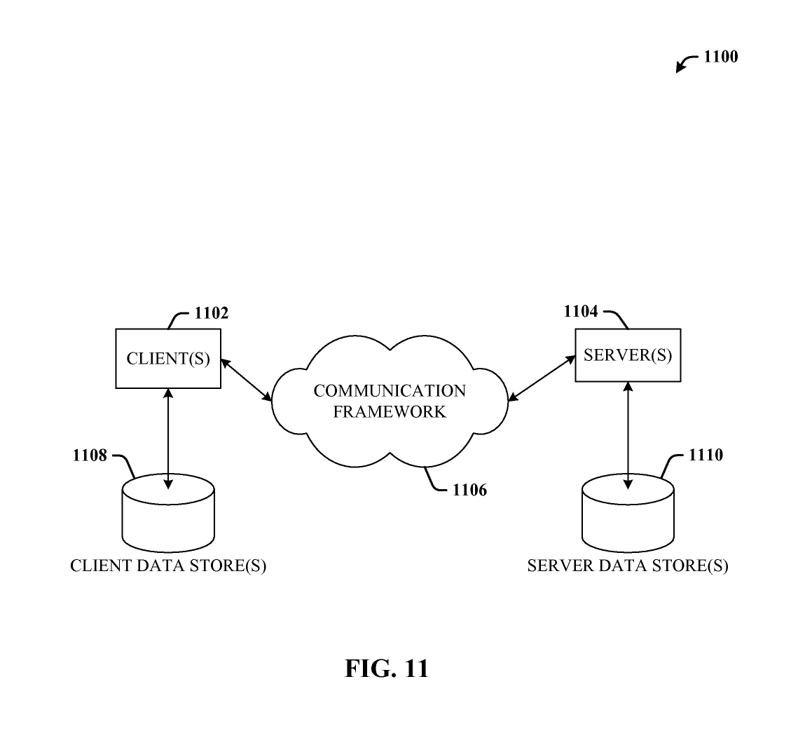

Referring now to FIG. 11, there is illustrated a schematic block diagram of an exemplary computer compilation system operable to execute the disclosed architecture. The system 1100 includes one or more client(s) 1102. The client(s) 1102 can be hardware and/or software (e.g., threads, processes, computing devices). The client(s) 1102 can house cookie(s) and/or associated contextual information by employing the claimed subject matter, for example.

The system 1100 also includes one or more server(s) 1104. The server(s) 1104 can also be hardware and/or software (e.g., threads, processes, computing devices). The servers 1104 can house threads to perform transformations by employing the claimed subject matter, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1 108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A computer implemented system that establishes or cultivates relationships in an enterprise environment, comprising:
a profiler component that monitors a transaction associated with an entity, the profile component constructs a comprehensive profile for the entity based upon the transaction;
an analysis component that receives an objective intended to benefit an enterprise, the analysis component determines a task suitable for the entity based upon the profile whereby the task facilitates accomplishment of the objective; and
a relationship component that compares the profile to a disparate profile associated with a disparate entity in order to automatically identify an advantageous relationship in connection with the objective.

2. The system of claim 1, the entity is at least one of an individual; a group of individuals; a team comprising multiple individuals with related enterprise-based goals; a department or division within a hierarchy of the enterprise; a set of individuals related by way of a social graph or network; or the enterprise.

3. The system of claim 1, the transaction is at least one of an update to schedule information associated with the entity; issuance of an employee review associated with the entity; issuance of a review of previous positions, objectives, or tasks associated with the entity; an access or input to an application, a tool, or a feature by the entity; an access or input to a data source by the entity; a change in a location of the entity; an update to a location history for the entity; a history of disparate entities in close proximity to the entity; communication of an electronic message associated with the entity or a message log thereof, an update to a call or a call log associated with the entity; an update to a social graph associated with the entity; a biometric reading associated with the entity; a reading of a facial expression, a verbal expression, or a gesture associated with the entity; a change in environment or situational state of the entity; or a corrective input performed by the entity.

4. The system of claim 1, the profiler component is operatively coupled to a set of servers employed to record the transaction.

5. The system of claim 1, the profiler component is operatively coupled to a set of sensors employed to monitor the entity, an environment associated with the entity, or a behavioral characteristic thereof in order to record the transaction.

6. The system of claim 1, the profile includes a determined proclivity characteristic associated with the entity that relates to an observed propensity determined based upon the transaction.

7. The system of claim 6, the proclivity characteristic relates to at least one of a preferred modality of communications by the entity; a punctuality of the entity; a rate of, a response time of, a target of, or a lack of response to a communication by the entity; a tendency to initiate, to attend, or to avoid meetings or interaction with a disparate entity; a preference related to organization; a preference related to assignment of responsibilities; a preference related to completion of responsibilities; a measure of social capital; a receptiveness by the entity to an interruption or a request; a current or recent emotional state of the entity; or a favorable strategy when directing an interruption or a request to the entity.

8. The system of claim 1, the objective is expressly input by at least one of the entity, a supervisor or administrator of the entity, or a supervisor or administrator of the enterprise or a disparate entity.

9. The system of claim 1, the objective is intelligently inferred based upon the transaction.

10. The system of claim 1, the advantageous relationship is identified based upon a characteristic featured in the disparate profile.

11. The system of claim 10, the characteristic is at least one of a desired characteristic for accomplishment of the objective or a correlate characteristic indicative of the desired characteristic.

12. The system of claim 1, the advantageous relationship is identified based upon a characteristic featured in the profile.

13. The system of claim 1, further comprising a coaching component that performs an automated action from a set of automated actions intended to cultivate the advantageous relationship between the entity and the disparate entity.

14. The system of claim 13, the automated action is at least one of providing an identity of the disparate entity to the entity; scheduling a meeting or a recurring meeting that includes the entity and the disparate entity based upon respective schedule information; setting up an impromptu engagement that includes the entity and the disparate entity based upon at least one of respective current activity or current geographic proximity; reminding the entity to reply to a communiqué; suggesting tailored content for the reply based upon the disparate profile; generating a communiqué on behalf of the entity and propagating the communiqué to the disparate entity; suggesting suitable behavior to the entity for interacting with the disparate entity based upon a proclivity characteristic associated with the disparate entity, recommending for or against a merger between the entity and the disparate entity, or suggesting competitive, collaborative, or defensive activities for the entity with respect to the disparate entity.

15. The system of claim 1, the task relates to interacting with an outside individual employed by a disparate enterprise and the relationship component identifies a disparate entity that has an established relationship with the outside individual.

16. The system of claim 15, the profiler component is operatively coupled to data mining component that searches public sources for information associated with the outside individual, the profiler component constructs an outsider profile for the outside individual.

17. A computer implemented method for facilitating cultivation of relationships in a business enterprise setting, comprising:
examining a transaction associated with an entity;
building a comprehensive profile for the entity based at least in part upon the transaction;
obtaining an objective aimed at benefiting an enterprise;
determining a task for accomplishing the objective based upon the profile; and
analyzing the profile and a disparate profile associated with a disparate entity for automatically identifying an advantageous relationship in connection with the objective.

18. The method of claim 17, further comprising at least one of the following acts:
employing one or more servers for logging the transaction;
employing one or more sensors for observing the entity, an environment associated with the entity, or an associated behavioral characteristic of the entity;
employing one or more data mining resources for constructing an outsider profile relating to a non-enterprise individual;
inferring a proclivity characteristic associated with an observed propensity of the entity based upon the transaction; or
including the proclivity characteristic in the profile associated with the entity.

19. The method of claim 17, further comprising at least one of the following acts:
receiving the objective as express input from at least one of the entity, a manager of the entity, a manager of the disparate entity, or a manager of the enterprise;
inferring the objective based upon the transaction;
selecting the advantageous relationship based upon a characteristic featured in the disparate profile;
selecting the advantageous relationship based upon a characteristic featured in the profile; or
executing an automated action from a set of automated actions for cultivating the advantageous relationship between the entity and the disparate entity.

20. A computer implemented system that identifies, facilitates, enriches, or nurtures relationships in a business enterprise environment, comprising:
a profiler component that monitors a transaction associated with an entity, the profile component creates or updates a comprehensive profile for the entity based upon the transaction;
an analysis component that receives an objective intended to benefit an enterprise, the analysis component infers a task suitable for the entity based upon the profile whereby the task relates to accomplishment of the objective;
a relationship component that examines the profile and a disparate profile associated with a disparate entity in order to automatically identify an advantageous relationship in connection with the task; and
a coaching component that performs an automated action from a set of automated actions intended to cultivate the advantageous relationship between the entity and the disparate entity.
